(19) United States
(12) Patent Application Publication
(10) Pub. No.: US 2009/0282102 A1
(43) Pub. Date: Nov. 12, 2009

(54) PLAYBACK DEVICE

(75) Inventors: Lucas Jacobus Franciscus Geurts, Eindhoven (NL); Anton Oguzhan Alford Andrews, Seattle, WA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,022

(22) PCT Filed: May 16, 2006
(86) PCT No.: PCT/IB06/51536

§ 371 Date: Nov. 20, 2007

(30) Foreign Application Priority Data
May 27, 2005 (EP) 05104539.1

(51) Int. Cl. G06F 15/16

(52) U.S. Cl. 709/204

(57) ABSTRACT

A playback device comprising playback means for playing content and wireless communication means for communicating with another device that is within communication range, further comprising content management means for identifying a content item available from the other device, for making the identified content item available for playback by the playback means for as long as the other device is in communication with the playback device and for retaining a ghost reference to the identified content item after detecting the other device is no longer in communication with the playback device.

Peer-to-peer Internet-based applications allow users to share their resources without the aid of central servers. This type of communication has been highlighted to a great degree in recent years because it enables the creation of large networks where “free” resources can be accessed by any user. For the same reasons, it has been hotly criticized by those involved in copyright protection.

The invention proposes a mechanism to exchange digital media content (like music tracks) within the boundaries of (digital) right management systems. If two or more users are in relatively close wireless communication proximity (e.g. using WiFi, Bluetooth) they can freely listen to each others music as stored on their personal devices. When they move beyond the communication reach (‘break the link’), the content items that they listened to, will remain as ghost references, including a playable part, on the device that leaves the network. For a legal transaction of media, the transferred media content will be limited in use, called ‘ghost’ references. With digital media right management it is possible to limited the usage i.e. available try out time and number of uses. Also there could be a mechanism to lower the playback ‘quality’ over time or through usage. For example, a music track could be high quality the first day of use, and after this it fades in quality (e.g. lower sample rate) or reduce in length (to 30 seconds which is allowed to publish freely). When a user buys a ‘ghost’ reference, he will get the full version. For this, ghost references will have associated metadata that links to an on-line shop, which can be used to directly activate an item.

Already known is a concept called ‘bookmarking a song’. It is part of a peer-to-peer proximity application in which users can tune into the music playback of somebody else's mobile device (see article: ‘tunA: Synchronized Music-Sharing on Handheld Devices’, by A. Bassoli, J. Moore and S. Agamanolis). “Users can bookmark a song that they hear while tuning into someone else's player, and later review these bookmarks, or download them to a computer where they might purchase the song for themselves.” However, in this concept no content is made available from one device to another.

The invention opens a new kind of distribution channel for the media industry (music, movies etc), while accommodating users to freely exchange digital media. The exchange of digital media is facilitated through a social network of friends which increases the speed of digital media distribution. New and ‘hot’ music will be spread via ‘word of mouth’ community interaction.

Typically when somebody likes a song or an album, he has to either go to a music shop to listen to it or visit an on-line website to get a preview of it. This hassle is gone in this scenario, and it could even facilitate impulse buying when this kind of exchange with an on-line service is combined on a mobile device (leading to more revenues for the media industry). Alternatively, users can explore their collected ‘ghost’ references (from a mobile device) on a PC or other Entertainment center devices to select what to buy and to visit a preview information page in an on-line store by directly selecting the item.

The invention can be applied in mobile media players and mobile phones (which in the future will have more and more media functions) but also in cars. The upgrading of ‘ghost’ references could be part of the functionality offered in a media manager/browser application that could be running on a PC, media center PC, streamium or entertainment hub.

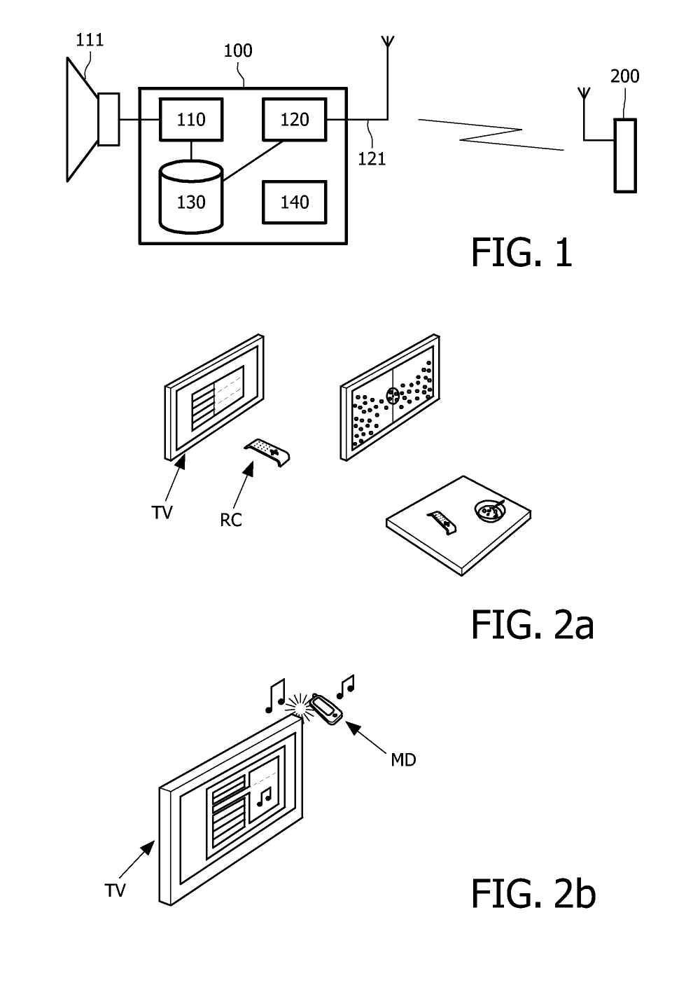

The invention is schematically illustrated in FIG. 1. which shows a playback device 100. The device 100 comprises a playback module 110, 111 for playing content such as music, video, audio books, text, podcasts, games, computer programs and so on. The device 100 further comprises a wireless communication module 120, 121 for communicating with another device 200 that is within communication range. Further the device 100 comprises an internal storage medium 130 such as a harddisk or flash memory on which content can be stored for later playback. It is to be noted that the storage medium 130 could also be external to the device 100, e.g. available over a network, or be detatchable/removable from the device 100. The device 100 further comprises content management module 140 discussed below.

A communication session with the other device 200 can be set up at the request of the user or automatically when the other device 200 is detected as being in range. A notification may be presented or a confirmation may be asked when detecting the other device 200 as being in range before establishing the communication session.

When the communication session has been set up, the content management module 140 identify one or more content items available from the other device 200. To this end the other device 200 may send a list of available content items, automatically or upon request. Alternatively the content management module 140 may receive a selection of one or more content items from the user (e.g. typed in manually or selected from a list on the device 100) and supply the selection to the other device 200, which can respond with the availability status of the selected content item(s).

Subsequently one or more content items that are present on the other device 200 are made available available by content management module 140 for playback by the playback module 110, 111 for as long as the other device is in communication with the playback device. The content could be copied to the storage medium 130 or streamed.

The content item can be processed before storing it so as to limit its quality, in accordance with copyright laws and regulations. For example:

Limit the number of times it can be played or copied.
The content item can only be used for a specific time (‘try out period’).
Downsized quality, e.g. convert the original to radio quality or lower bit rate.
Limited content item duration (e.g. 30 seconds).
Insert spoken commercial messages (e.g. ‘this track is offered by’).

After the content management module 140 detects the other device is no longer in communication with the playback device 100, a ghost reference to the identified content item is retained on the storage medium 130. Together with the ghost reference a sample version may be retained. The sample version could be generated by the device 100 by e.g. saving a 30-second fragment of the content item or an automatically generated summary or a version. The sample version could also have been received from the other device 200.

Alternatively a reduced quality version of the full content item can be retained. The reduced quality version could be e.g. a lower sample rate version, a mono version of an original stereo version, or a version containing noise or other interruptions.

The quality may be further reduced over time. For instance, the quality may be full quality over a first period, say one day, lower quality (e.g. radio quality) over a second period, say one week, and after that an even lower quality version or only a small part is retained.

Further the content management module 140 is configured for initiating a purchase of the identified content item when the ghost reference is accessed. Ghost references preferably have associated metadata that links to an on-line shop, which can be used to directly activate an item. Preferably the metadata links to the same on-line shop where the identified content item was originally purchased. This way this shop is assured of repeat business. Alternatively the device 100 could be programmed to always access the same on-line shop to initiate the purchase.

A more general reference is also possible. For many types of content there is a standardized scheme that enables identification of the content at a shop. The ghost reference may contain, for example, a Uniform Resource Locator (URL) or other Uniform Content Identifier (URI) that points to a website or other Internet server where the content item may be obtained. It can also be a code such as an ISBN or another number identifying the content item at an e-commerce system. The ghost reference can also simply be the title of the content item.

The ghost reference can also be obtained by computing a robust hash or fingerprint for the content item. An example of an algorithm to compute such a robust hash may be found in international patent application WO 2002/065782 (attorney docket PHNL010110) by the same applicant as the present application. The ghost reference can also be contained in a digital watermark embedded in the content item.

The purchasing can be done directly on the device 100, or in a more rich way on a PC or media centre at home, where the ghost reference is used to enter an on-line shopping application pointing to the content item in the on-line shop. In the latter case, the ghost reference is transferred to the PC or media centre.

Initiating the purchase can for example be done over a wireless Internet connection or other wireless transmission to the on-line shop. For instance, if the device 100 is a mobile phone, an SMS or MMS or similar message could be used to initiate the purchase of the content item.

Alternatively the ghost references can be transferred to a PC or other device when the device 100 is brought into contact with said PC or other device. The purchase can then be initiated from the PC, which usually is more convenient than purchasing from a portable and therefore small device like device 100.

The following additions can be thought of:

Pre-paid transfer. The user that owns a content item could pay in advance for that content item to be made available to others.

If the person that received a content item buys the full quality version, the person from which it originates gets an extra bonus (e.g. for free digital media downloads).

The invention could be combined with interest profiling. The interest profile stored on one device (or active playlist or sub profile) is used to filter the content that is stored on the second device with which it has a link. Only the relevant content items will be transferred that fit the profile or current selection.

The envisioned interaction style would be to use close proximity detection e.g. possible using Near Field Communication (NFC). The principle of getting a downgraded or limited copy of a content item, can be extended to every transaction with NFC. For example, when the tickets of a cinema movie are bought using NFC (e.g. via a creditcard micro transaction), the phone could also receive the trailer of the movie, game demo or the exclusive rights to buy the video release of the movie for a cheaper price.

An additional advantage is that the ‘ghost’ references could be added to a person's media collection just like normal songs. The user is able ‘upgrade’ songs (buy) to acceptable quality at any time and mix them with regular content items in playback/playlists. Also the media player can remind a user to buy/upgrade a ghost reference when it is played a lot.

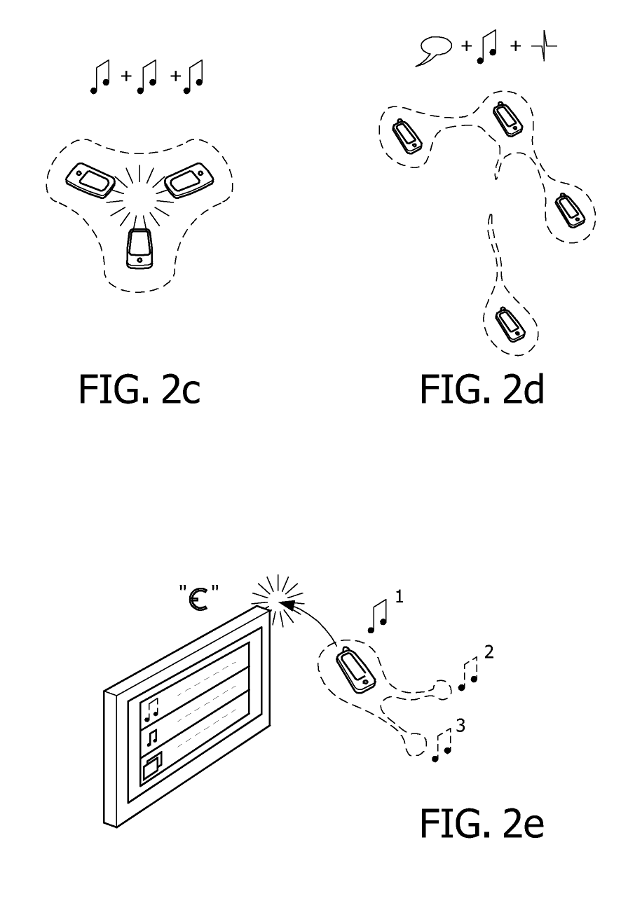

The invention will now be further explained by means of a story involving a fictional user named ‘Aaron’ who is using the invention. The story starts when Aaron browses music and creates a playlist on the fly during breakfast. As shown in FIG. 2(a), Aaron uses his remote control (RC) to pull up his ‘lifestyle browser’ on the TV screen. He chooses to ‘tune’ through his music collection, accessing a single spatial overview of all of his music. Using the remote control, he quickly tunes to the genre he wants and finds a track he likes. He ‘clicks’ this track, and his music tuning-field instantly reorganizes itself around his selection (by matching similar music). A little later, he selects another two tracks in a slightly different genre. Happy with the current selection, he switches over to a standard ‘playlist’ view mode.

Aaron leaves home in a hurry whilst his playlist is still playing. He transfers the active playlist to his mobile device (MD) by ‘tagging’ the TV with it, as illustrated in FIG. 2(b).

Aaron has arranged to go track racing with his friends on mountain bikes. He realizes that he is almost late, and needs to leave home in a hurry, but wants to take his music with him. Aaron simply ‘tags’ (‘touch-links’) a clearly marked part of his TV screen (home media center) with his mobile device to initiate smart synchronization, transferring the active playlist from his home hub to his mobile hub. The active playlist transfers from the screen to the mobile because the screen is showing the playlist as the main active application, whereas his mobile device is in neutral mode, with no active applications. The music is now playing on both devices. Aaron switches off the home media center and leaves home. His music is now playing through sports earphones.

Aaron and his two friends decide to share some of their latest tracks to make a group playlist for the race ahead. As illustrated in FIG. 2(c), they touch-link their players/mobile-devices to create an ad-hoc share community based on proximity (NFC). This allows them to create a shared playlist that they can enjoy together whilst racing, using WiFi. Aaron activates his heart-rate monitor, stashes his mobile in his backpack and they start biking together. As long as they stay within range, they can listen to their common ‘channel’. They can use their voice link and their earpieces to speak over the top of the music with each other as they compete.

As illustrated in FIG. 2(d), when they separate later, moving out of (bluetooth?) range, the proximity link breaks and each person is left with preview versions of the other's tracks from the common playlist. A preview can be listened to for only a limited number of times and cannot be copied, but does contain a link to allow online purchase of that track.

As illustrated in FIG. 2(e), Aaron arrives back home and sets his mobile device down on the marked area of the home media center/screen, initiating smart synchronization. His system sees that he has new performance data, and so the lifestyle browser shows an option to open his race-diary. Aaron confirms, and the new performance data is automatically synchronized. Aaron can now compare it with his last few performances and see a visualization of his progress. Satisfied, he closes the diary. His lifestyle browser also points out that he has some new preview-tracks (from the shared playlist earlier). He clicks on one of the preview-tracks, following its link to an online music retail site. Using his living room screen and speakers for a rich shopping experience, he browses the tracks video-clips and browses related music and albums. He buys some of the tracks and clips using his RC and his authorized domain ID, without interrupting his enjoyment of the music experience.

In short, the invention proposes is a mechanism to legally exchange digital media content within the boundaries of (digital) right management systems. If two or more users are in close wireless communication proximity, they can freely listen to each others music as stored on their personal devices. When they move beyond the communication reach, the content items that they listened to, will remain as ghost references, including a playable part, on the device that leaves the network. For a legal transaction of media, the copied media content will be limited in use. With digital media right management it is possible to limited the usage i.e. available try-out time and number of uses. Also there could be a mechanism to lower the playback ‘quality’ over time or through usage. For example, a music track could be high quality the first day of use, and after this it fades in quality (e.g. lower sample rate) or reduces in length (to e.g. 30 seconds). When a user buys a reduced ‘quality’ item, he will get the full version. For this, ghost references will have associated metadata that links to an on-line shop, which can be used to directly activate an item.

1. A playback devices, comprising:
playback means for playing content;
wireless communication means for communicating with another playback device that is within communication range; and
content management means for identifying a content item available from the other device, causing the identified content item to be copied from the other device to a storage medium included in the playback device, enabling playback by the playback means for as long as the other device is in communication with the playback device and retaining a ghost reference to the identified content item in the place of the content item itself after detecting the other device is no longer in communication with the playback device.

2. (canceled)

3. The device of claim 1, wherein the content management means are configured for retaining a sample part of the identified content item after detecting the other device is no longer in communication with the playback device, sample part being retained together with the ghost reference.

4. The device of claim 3, wherein the sample part is received together with the identified content item.

5. (canceled)

6. The device of claim 3, wherein the sample part is taken as the first n seconds of the identified content item, where n is a predetermined amount of time.

7. The device of claim 3, further comprising summarizing means for deriving the sample part from the identified content item.

8. The device of claim 1, wherein the content management means are configured for retaining a reduced quality version of the identified content item after detecting the other device is no longer in communication with the playback device.

9. The device of claim 8, wherein the reduced quality version includes one of a lower sample rate version, a mono version of an original stereo version, and a version containing noise or other interruptions.

10. The device of claim 8, wherein the content management means are configured for reducing the quality of the reduced quality version further over time and/or further upon each playback of the reduced quality version.

11. The device of claim 1, wherein the content management means are configured for initiating a purchase of the identified content item when the ghost reference is accessed.
